(19) United States
(12) Patent Application Publication
(10) Pub. No.: US 2016/0207469 A1
(43) Pub. Date: Jul. 21, 2016

(54) BOX APPARATUS FOR A VEHICLE

(71) Applicant: KOJIMA INDUSTRIES CORPORATION, Toyota-shi, Aichi-ken (JP)

(72) Inventor: Hiroaki ISHIKAWA, Toyota-shi, Aichi-ken (JP)

(73) Assignee: KOJIMA INDUSTRIES CORPORATION, Toyota-shi, Aichi-ken (JP)

(21) Appl. No.: 15/022,676

(22) PCT Filed: Jun. 13, 2014
(86) PCT No.: PCT/JP2014/065690

§ 371 Date: Mar. 17, 2016

(30) Foreign Application Priority Data
Sep. 19, 2013 (JP) 2013-194439

(51) Int. Cl. B60R 7/06

(52) U.S. Cl. CPC B60R 7/06; B60R 2011/0047

(57) ABSTRACT

An outer member and an inner member are coupled to each other by causing an engagement-male portion to engage with an engagement-female portion. Therefore, vibration-welding of the outer member with the inner member can be removed and thus, problems generated during vibration-welding can be avoided. Further, a front wall panel and a bottom wall panel are connected to each other via an integral hinge and a rear wall panel and the bottom wall panel are connected to each other via another integral hinge. Therefore, the inner member at a stage after having been manufactured and before being coupled with the outer member can be developed to a flat plate configuration.

### TECHNICAL FIELD

The present invention relates to a box apparatus for a vehicle, for example, a glove box apparatus for a vehicle.

### BACKGROUND

As illustrated in FIG. 5, a conventional box apparatus 1, more particularly, a conventional glove box apparatus for a vehicle includes an inner member 2 having an opening 2a that opens upward and another opening 2b that opens toward a passenger room, and an outer member 3 vibration-welded to a frame of the inner member 2 defining the opening 2b therein from a passenger room side and covering the opening 2b of the inner member 2.

The inner member 2 and the outer member 3 are manufactured by molding, and, in some cases, are coated or napped in a secondary process. Then, after a lock device (not shown) for holding the box apparatus at a closed position is coupled to the box apparatus 1, the members 2 and 3 are vibration-welded to each other.

### PROBLEMS TO BE SOLVED

However, there are the following problems (A) and (B) with the conventional box apparatus 1:

(A) Problems Generated by Vibration-Welding

(A-1) Since a structure and a size of the inner member 2 and the outer member 3 vary according to a type of vehicle, a plurality of vibration-welding apparatuses have to be prepared for each type of vehicle, which increases manufacturing costs. Further, since the size of the vibration-welding apparatus is large, and since the box apparatus 1 cannot be manufactured at a factory without a vibration-welding apparatus, places for manufacturing the box apparatus 1 are limited, and thus, it is difficult to make the box apparatus at various manufacturing places.

(A-2) As illustrated in FIG. 6, ribs 2c used for vibration-welding with the outer member 3 are provided at an outer member-side surface of the frame of the inner member 2 defining the opening 2b. Because the ribs 2c are provided, a direction of drawing-out a die for molding the inner member 2 is directed in a front-rear direction (i.e., a direction toward-away from a passenger room) perpendicular or substantially perpendicular to an up-down direction. As a result, if forming the inner member 2 is tried without using a sliding die, as illustrated in FIGS. 5 and 7, an inwardly curled flange 2d may be formed at the inner member 2. The inwardly curled flange 2d may decrease a housing space of the box 1 and may decrease a design grade.

(B) Problems Generated During the Secondary Process Added to the Inner Member 2

Since a structure of the inner member 2 is relatively complicated, and since coating and napping to the inner member 2 are to be conducted through the opening 2a or the opening 2b, the secondary process may be accompanied by difficulties.

### RELATED ART DOCUMENT

### Patent Document

Document 1: Patent Publication No. JP2010-13035

### BRIEF SUMMARY

An object of the invention is to provide a box apparatus for a vehicle which can solve at least one of the problems generated during vibration-welding and the problems generated during the secondary process added onto the inner member.

### Means for Solving the Problems

The present invention for achieving the above object is as follows:

(1) A box apparatus for a vehicle comprises an outer member and an inner member coupled to the outer member.

The outer member includes a design panel a passenger room-side surface of which defines a design surface, and a pair of side panels extending in a direction away from the passenger room from opposite ends of the design panel located in a width direction of the box apparatus.

The inner member includes a front wall panel, a bottom wall panel and a rear wall panel, the front wall panel covering a surface of the design panel opposite the design surface from a side opposite the passenger room, the bottom wall panel extending from a lower end of the front wall panel in the direction away from the passenger room, the rear wall panel extending upward from an end of the bottom wall panel further from the passenger room.

The design panel of the outer member covered with the front wall panel of the inner member, the pair of side panels of the outer member, the bottom wall panel of the inner member and the rear wall panel of the inner member define a housing space which is open upward.

The outer member and the inner member are manufactured separately from each other and are coupled to each other by causing an engagement-male portion formed in one of the outer member and the inner member to engage with an engagement-female portion formed in the other of the outer member and the inner member.

(2) The box apparatus according to item (1) above, further comprises a rotational shaft, a lock device and a stopper.

The rotational shaft is rotatably supported by a bearing housing provided to a fixed member which is fixed to a vehicle body whereby the box apparatus is rotatable relative to the fixed member between an open position and a closed position.

The lock device locks the box apparatus at the closed position relative to the fixed member.

The stopper restricts the box apparatus to rotate relative to the fixed member further than the open position when the box apparatus is staying at the open position.

All of the rotational shaft, the lock device and the stopper are provided at the outer member.

(3) The box apparatus according to item (1) or (2) above, wherein the front wall panel is connected to the bottom wall panel via an integral hinge, and the rear wall panel is connected to the bottom wall panel via another integral hinge.

### Technical Advantages

According to the box apparatus of item (1) above, since the outer member and the inner member are manufactured separately from each other and are coupled to each other by causing the engagement-male portion formed in one of the outer member and the inner member to engage with the engagement-female portion formed in the other of the outer member and the inner member, vibration-welding of the outer member with the inner member can be removed. Therefore, the problems generated during vibration-welding can be omitted. More particularly, a vibration-welding apparatus is not required to be provided and the box apparatus can be manufactured even at a factory having no vibration-welding apparatus, whereby the box apparatus can be manufactured at various manufacturing places. Further, an inwardly curled flange can be suppressed from being formed, whereby a decrease in a housing space of the box apparatus and a degradation in design of the box apparatus, due to the inwardly curled flange can be suppressed.

According to the box apparatus of item (2) above, since all of the rotational shaft, the lock device and the stopper are provided at the outer member, an external force loaded on the box apparatus during using the box apparatus can be shifted to the outer member. Therefore, despite that the outer member and the inner member are not vibration-welded to each other and that a coupling strength between the outer member and the inner member is relatively low, decoupling of the outer member from the inner member and breakage of the box apparatus can be suppressed.

According to the box apparatus of item (3) above, since the front wall panel is connected to the bottom wall panel via the integral hinge and the rear wall panel is connected to the bottom wall panel via another integral hinge, the inner member can be held at a flat (including substantially flat) plate state at a stage after the inner member has been molded and before the inner member is coupled to the outer member. Since the flat plate-type shape of the inner member at that stage is much simpler than the box-type shape of the inner member of the conventional box apparatus, the secondary process such as coating and napping added to the inner member can be conducted more easily than in the conventional inner member.

### BRIEF DESCRIPTION OF DRAWINGS

FIG. 1 is a perspective view of a box apparatus for a vehicle where parts are decoupled from each other, according to one embodiment of the present invention.

FIG. 2 is a perspective view of the box apparatus for a vehicle where the parts are coupled with each other, according to FIG. 1.

FIG. 3 is a side view of the box apparatus for a vehicle according to FIG. 1.

FIG. 4 is a perspective view of an inner member of the box apparatus for a vehicle according to FIG. 1, at a stage after the inner member has been manufactured and before the inner member is coupled with an outer member.

FIG. 5 is a perspective view of a conventional box apparatus for a vehicle where parts are decoupled from each other.

FIG. 6 is a side view of an inner member of the conventional box apparatus for a vehicle of FIG. 5, at a stage after the inner member has been manufactured and before the inner member is welded with an outer member.

FIG. 7 is a cross-sectional view taken along line A-A of FIG. 6.

### DETAILED DESCRIPTION

A box apparatus for a vehicle according to one embodiment of the present invention will be explained below with reference to drawings. In the drawings, “UP” shows an upward direction and “IN” shows a passenger room-side direction (i.e., a rearward direction of a vehicle).

A box apparatus 10 of a vehicle (hereinafter, merely “a box apparatus 10”) according to the present invention can be, for example, a glove box disposed at an instrument panel located in front of a front passenger seat of a vehicle. However, the box apparatus 10 may be another box apparatus disposed at the instrument panel or a console panel of a vehicle. In the description below, the glove box of a vehicle will be taken as an example of the box apparatus 10.

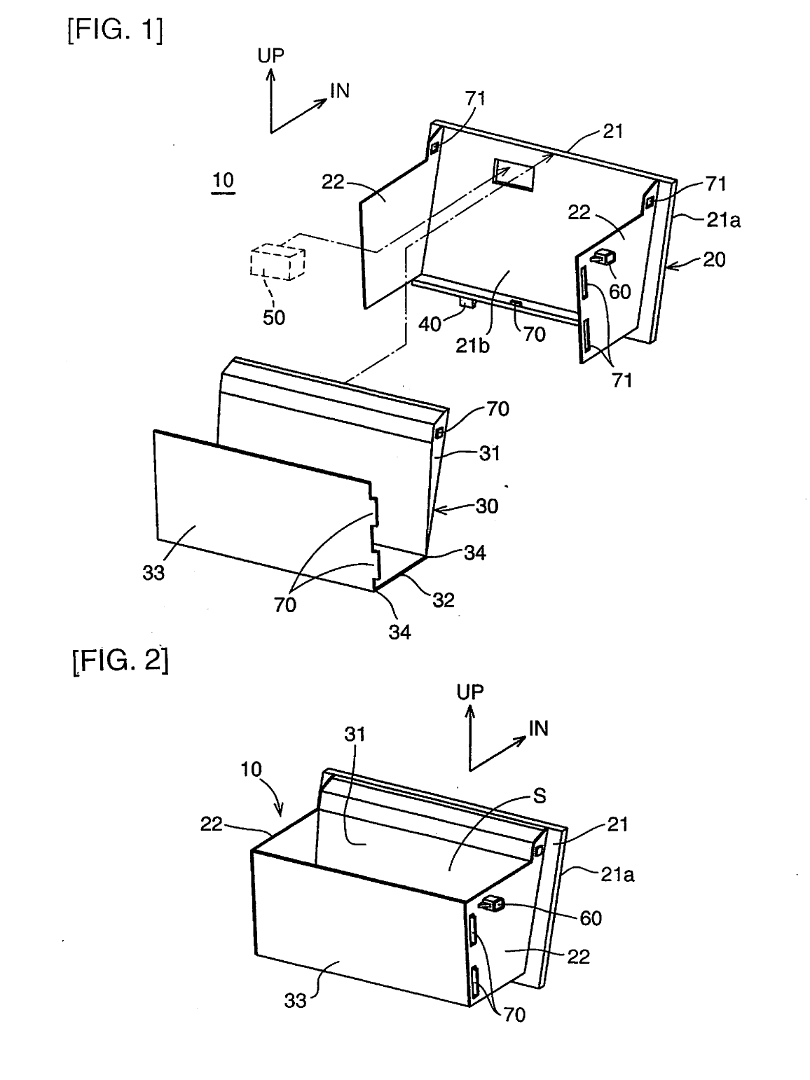

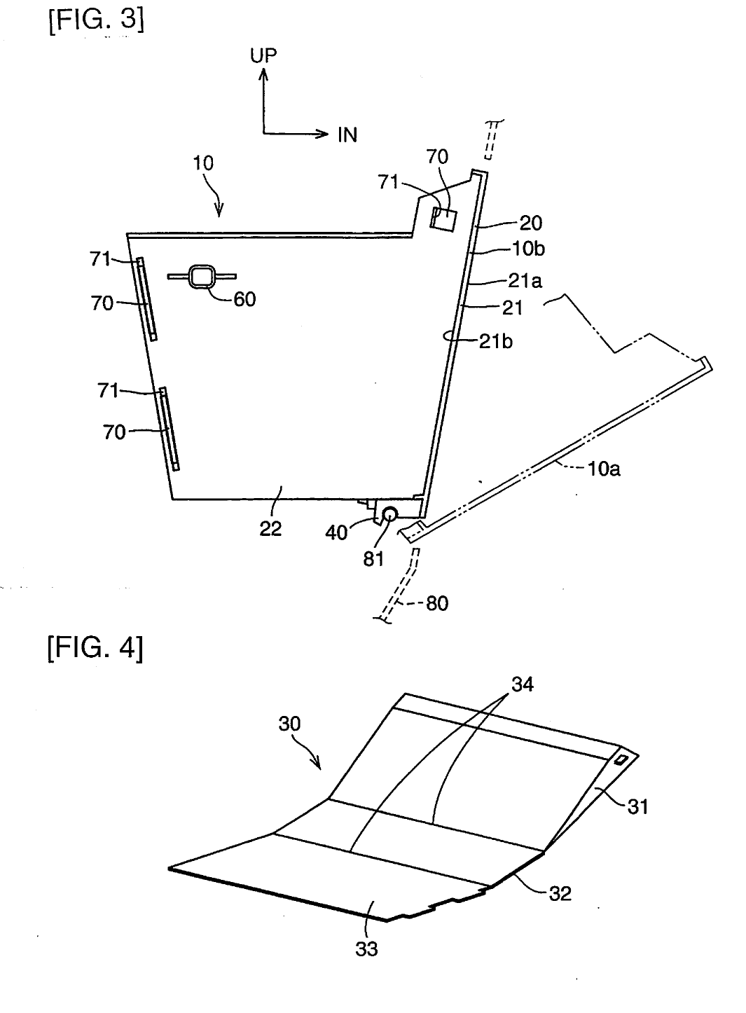

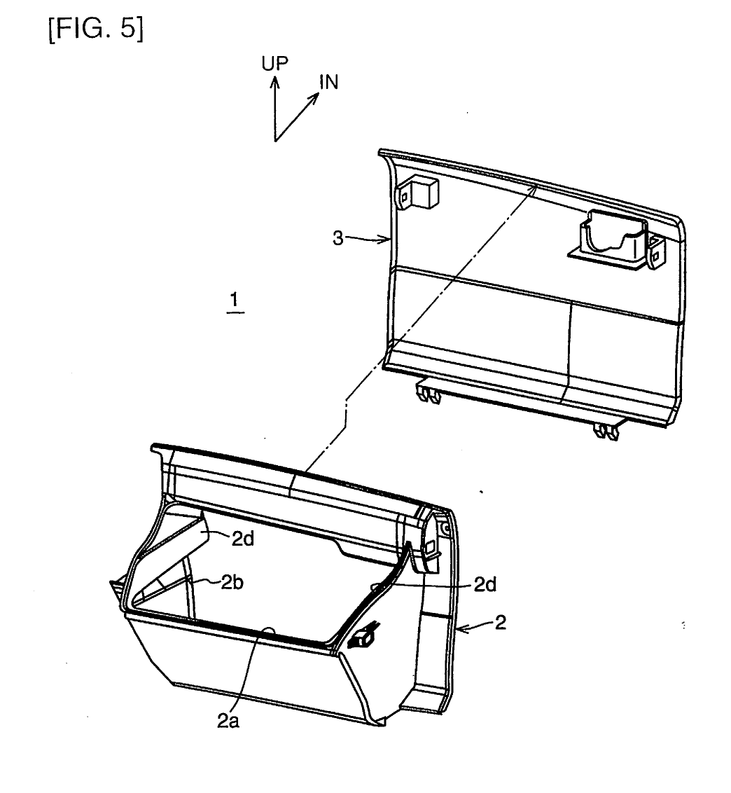

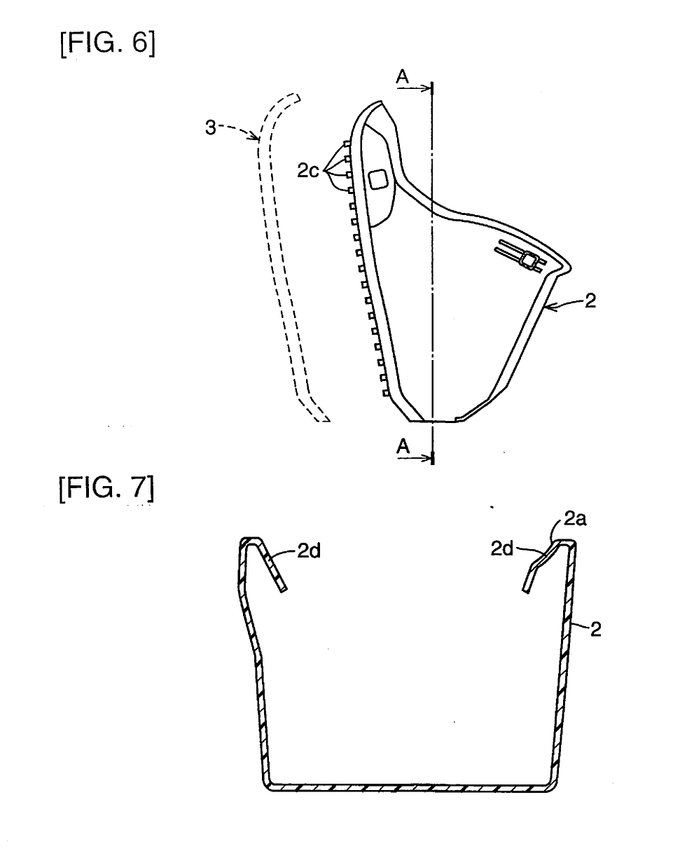

As illustrated in FIG. 1, the box apparatus 10 includes an outer member 20 and an inner member 30. The box apparatus 10 further includes a rotational shaft 40 (shown in FIG. 3), a lock device 50 and a stopper 60.

The outer member 20 is made from resin and is molded to a single, integral member. As illustrated in FIG. 1, the outer member 20 includes a design panel 21 and a pair of side panels 22. A passenger room-side surface (a rear-side surface in a front-rear direction of the vehicle) 21a of the design panel 21 defines a design surface. The pair of side panels 22 extend in a direction away from the passenger room (i.e., a frontward direction of a vehicle), from opposite ends (opposite ends in a width direction of the vehicle) of the outer member 20, more particularly, from opposite ends (opposite ends in a right-left direction of the vehicle) of a back surface (a frontward surface) 21b of the design panel 21 opposite the passenger room-side surface 21a of the design panel 21. Each of the design panel 21 and the side panels 22 has a plate-like configuration.

A single inner member 30 is made from resin and is molded to a single, integral member. The inner member 30 includes a front wall panel (which may be called as a cover panel) 31, a bottom wall panel 32 and a rear wall panel 33. The front wall panel 31 covers a large part (a portion) of the surface 21b of the design panel 21 opposite the design surface from a side opposite the passenger room. The bottom wall panel 32 extends from a lower end of the front wall panel 31 in the direction away from the passenger room. The rear wall panel 33 extends upward from an end of the bottom wall panel 32 further from the passenger room. Each of the front wall panel 31, the bottom wall panel 32 and the rear wall panel 33 has a plate-like configuration. As illustrated in FIG. 2, the lock device 50 can be covered with the front wall panel 31 from a housing space S-side.

As illustrated in FIG. 1, the front wall panel 31 is connected to the bottom wall panel 32 via an integral hinge 34, and the rear wall panel 33 is connected to the bottom wall panel 32 via another integral hinge 34. A thickness of each of the integral hinges 34, 34 is much smaller than a thickness of each of the front wall panel 33, the bottom wall panel 32 and the rear wall panel 33. Since the integral hinges 34 are provided, the inner member 30 can be molded in the form of a single member and, as illustrated in FIG. 4, the inner member 30 at the stage after the inner member has been manufactured and before the inner member is coupled with the outer member 20 can be developed to a configuration of a flat (or substantially flat) plate.

As illustrated in FIG. 1, the outer member 20 and the inner member 30 are manufactured separately from each other. The outer member 20 and the inner member 30 are fixedly coupled to each other by causing an engagement-male portion (i.e., a hook or an engaging portion) 70 formed in one of the outer member 20 and the inner member 30 to engage with an engagement-female portion (i.e., a hook receiving portion or an engaged portion) 71 formed in the other of the outer member 20 and the inner member 30. Therefore, the outer member 20 and the inner member 30 are not vibration-welded to each other, and a vibration-welding apparatus used for vibration-welding is not required to be provided. Further, a fastening member such as a screw and a bolt is not used for coupling the outer member 20 and the inner member 30 to each other.

The design panel 21 of the outer member 20 covered with the front wall panel 31 of the inner member 30, the pair of side panels 22 of the outer member 20, the bottom wall panel 32 of the inner member 30 and the rear wall panel 33 of the inner member 30 define the housing space S (shown in FIG. 2) of the box apparatus 10 which is open upward.

As illustrated in FIG. 3, the rotational shaft 40 is provided at a lower portion of the box apparatus 10. The rotational shaft 40 is formed integrally with the outer member 20. The rotational shaft 40 is rotatably supported by a bearing housing 81 fixed to a fixed member 80 which is fixed to a vehicle body, whereby the box apparatus 10 is rotatable relative to the fixed member 80 between an open position 10a and a closed position 10b.

The lock device 50 locks the box apparatus 10 at the closed position 10b relative to the fixed member 80. As illustrated in FIG. 1, the lock device 50 is manufactured separately from the outer member 20 and the inner member 30. The lock device 50 is provided (disposed) at the surface 21b of the design panel 21 opposite the design surface 21a of the design panel 21.

The stopper 60 is formed integrally with the side panel 22 of the outer member 20. The stopper 60 contacts a stopper receiving portion (not shown) provided at the fixed member 80 when the box apparatus 10 is at the open position 10a relative to the fixed member 80, whereby the box apparatus 10 is prevented from rotating further than the open position relative to the fixed member 80.

By unlocking the lock device 50, the box apparatus 10 can rotate in an opening direction about the rotational shaft 40 in a direction from the closed position up to the open position 10a where the stopper 60 contacts the stopper receiving portion (not shown) to stop the opening rotation of the box apparatus 10. When rotating in a closing direction the box apparatus 10 from the open position to the closed position 10b about the rotational shaft 40, the box apparatus 10 is raised up manually. When the lock device 50 comes to the closed position 10b and is locked at the closed position 10b, the box apparatus 10 can hold its closed position.

Next, operation and technical advantages of the embodiment of the present invention will be explained.

(i) Since the outer member 20 and the inner member 30 are manufactured separately from each other and are coupled to each other by causing the engagement-male portion 70 formed in one of the outer member 20 and the inner member 30 to engage with the engagement-female portion 71 formed in the other of the outer member 20 and the inner member 30, vibration-welding of the outer member 20 with the inner member 30 can be omitted. Therefore, the problems generated during vibration-welding can be eliminated. More particularly, a vibration-welding apparatus is not required to be provided and the box apparatus 10 can be manufactured even at a factory having no vibration-welding apparatus. Thus, the box apparatus 10 can be manufactured at various manufacturing places. Further, the inwardly curled flange of the conventional box apparatus may be prevented from being formed, whereby a decrease in a housing space of the box apparatus and a degradation in design of the box apparatus, due to the inwardly curled flange can be suppressed.

(ii) Since all of the rotational shaft 40, the lock device 50 and the stopper 60 are provided at the outer member 20, an external force loaded on the box apparatus 10 during using the box apparatus 10 can be shifted to the outer member 20. Therefore, despite that the outer member 20 and the inner member 30 are not vibration-welded to each other and that a coupling strength between the outer member 20 and the inner member 30 is relatively low, decoupling of the outer member 20 from the inner member 30 can be suppressed and damage to the box apparatus 10 can be suppressed.

(iii) Since the front wall panel 31 is connected to the bottom wall panel 32 via the integral hinge 34 and the rear wall panel 33 is connected to the bottom wall panel 32 via another integral hinge 34, the inner member 30 can be held at a flat (including substantially flat) plate state at a stage after the inner member 30 has been molded and before the inner member 30 is coupled to the outer member. As a result, (iii-) the secondary process such as coating and napping added to the inner member 30 can be conducted more easily than the inner member of the conventional box apparatus. Further, (iii-2) since a structure of a die for molding the inner member 30 can be simplified, a temperature distribution inside the die can be substantially uniform, so that thermal deformation of the inner member 30 molded using the die can be greatly suppressed.

(iv) Since the outer member 20 includes the design panel 21 and the pair of side panels 22, and since the inner member 30 includes the front wall panel 31, the bottom wall panel 32 and the rear wall panel 33, the box apparatus 10 is a combination of the outer member 20 of a three-wall type and the inner member 30 of a three-wall type. As a result, a stable and high quality molded box apparatus 10 can be obtained.

### EXPLANATION OF REFERENCE NUMERALS

10 box apparatus of a vehicle
10a open position
10b closed position
20 outer member
21 design panel
21a passenger room-side surface of the design panel
21b surface of the design panel opposite the passenger room-side surface
22 side panel
30 inner member
31 front wall panel
32 bottom wall panel
33 rear wall panel
34 integral hinge
40 rotational shaft
50 lock device
60 stopper
70 engagement-male portion
71 engagement-female portion
80 fixed member
81 bearing housing
S housing space

1. A box apparatus for a vehicle comprising:
an outer member; and
an inner member coupled to the outer member,
wherein the outer member includes a design panel a passenger room-side surface of which defines a design surface, and a pair of side panels extending in a direction away from the passenger room from opposite ends of the design panel located in a width direction of the box apparatus,
wherein the inner member includes a front wall panel, a bottom wall panel and a rear wall panel, the front wall panel covering a surface of the design panel opposite the design surface from a side opposite the passenger room, the bottom wall panel extending from a lower end of the front wall panel in the direction away from the passenger room, the rear wall panel extending upward from an end of the bottom wall panel further from the passenger room,
wherein the design panel of the outer member covered with the front wall panel of the inner member, the pair of side panels of the outer member, the bottom wall panel of the inner member and the rear wall panel of the inner member define a housing space which is open upward, and
wherein the outer member and the inner member are manufactured separately from each other and are coupled to each other by causing an engagement-male portion formed in one of the outer member and the inner member to engage with an engagement-female portion formed in the other of the outer member and the inner member.

2. The box apparatus according to claim 1, further comprising:
a rotational shaft;
a lock device; and
a stopper,
wherein the rotational shaft is rotatably supported by a bearing housing provided to a fixed member which is fixed to a vehicle body whereby the box apparatus is rotatable relative to the fixed member between an open position and a closed position,
wherein the lock device locks the box apparatus at the closed position relative to the fixed member,
wherein the stopper restricts the box apparatus to rotate relative to the fixed member further than the open position when the box apparatus is staying at the open position, and
wherein all of the rotational shaft, the lock device and the stopper are provided at the outer member.

3. The box apparatus according to claim 1, wherein
the front wall panel is connected to the bottom wall panel via an integral hinge, and
the rear wall panel is connected to the bottom wall panel via another integral hinge.

4. The box apparatus according to claim 2, wherein
the front wall panel is connected to the bottom wall panel via an integral hinge, and
the rear wall panel is connected to the bottom wall panel via another integral hinge.
